(19) United States
(12) Patent Application Publication
(10) Pub. No.: US 2020/0094713 A1
(43) Pub. Date: Mar. 26, 2020

(54) VEHICLE SEAT WITH ELECTRONIC SYSTEM

(71) Applicant: Faurecia Automotive Seating, LLC, Auburn Hills, MI (US)

(72) Inventor: Alex SALMU, Auburn Hills, MI (US)

(21) Appl. No.: 16/140,970

(22) Filed: Sep. 25, 2018

(51) Int. Cl. B60N 2/42; A47C 7/18; B60N 2/90; G01L 5/00

(52) U.S. Cl. CPC B60N 2/42; A47C 7/18; B60R 21/0132; G01L 5/0052; B60N 2002/981; B60N 2/90

(57) ABSTRACT

A vehicle seat is provided with an electronic system. The electronic system is configured to detect impacts to the vehicle seat.

### BACKGROUND

The present disclosure relates to occupant support, and particularly to a vehicle seat with an electronic system. More particularly, the present disclosure relates to an electronic system configured to detect impacts.

### SUMMARY

According to the present disclosure, a vehicle seat comprises a seat bottom and a seat back coupled to the seat bottom to extend upwardly away from the seat bottom and move relative to the seat bottom. The vehicle seat further includes an electronic system coupled to the vehicle seat and configured to detect impacts to the vehicle seat.

In illustrative embodiments, the electronic system of the vehicle seat is an impact detection system coupled to one of the seat bottom and the seat back. The impact detection system comprises conductive particle electronic foam, a sensor configured to detect changes in density of the conductive particle electronic foam, and a microcomputer configured to analyze the detected changes in density and transmit a message to a remote device.

In illustrative embodiments, the conductive particle electronic foam includes a foam material and semi-conductive particles of one of graphene or nickel dispersed in a predetermined density in the foam material. In response to an external impact force applied to the conductive particle electronic foam, the semi-conductive particles generate a static charge and the sensor detects a voltage from the static charge.

In illustrative embodiments, a circuit remains open when no external impact force acts upon the foam material. The circuit closes and conducts a static charge when an impact force acts up on the foam.

In illustrative embodiments, the microcomputer is configured to determine one or more of impact velocity, acceleration, magnitude, and direction. The microcomputer may be coupled to a transmitter and is configured to transmit a message to one or more predetermined remote devices in response to a result of the analyzed voltage meeting predefined criteria.

In illustrative embodiments, the impact detection system comprises a plurality of sensors positioned in the seat bottom and the seat back, and the seat back includes a headrest. The sensor may comprise one or more of strain gauges and micro-voltages sensors. In some embodiments, the transmitted message relays the vehicle occupant has experienced head trauma.

In some embodiments, the microcomputer is arranged in the seat back and the plurality of sensors are configured to wirelessly communicate detected changes in density to the microcomputer. The sensor may comprise one or more of strain gauges and micro-voltages sensors. That transmitter may provide a notification or relay a message that the vehicle occupant has experienced a head trauma.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective and diagrammatic view of an occupant support adapted for use in a passenger vehicle showing that the occupant support includes a seat bottom mounted to a floor of the vehicle, a seat back mounted to the seat bottom, and a headrest included in the seat back, and each of the seat bottom and the seat back include an impact detection system configured to detect an impact of an occupant against on or more of the seat bottom, seat back, and headrest;

FIG. 2A is a diagrammatic view of a first embodiment of the impact detection system showing that the impact detection system includes a conductive particle electronic foam, a plurality of voltage sensors, and a microcomputer in which the plurality of sensors are coupled to the microprocessor to transmit detected voltages;

FIG. 2B is a diagrammatic view of the impact detection system of FIG. 2A showing a change in density of the conductive particle electronic foam in response to an applied force and a resultant voltage being detected by one or more of the sensors;

FIG. 3 is a diagrammatic view of a seat back including a backrest and a headrest showing that the headrest sensors of the impact detection system are wirelessly coupled to the microcomputer in the seat back;

FIG. 4 is a partial sectional view of a portion of the vehicle seat showing the conductive particle electronic foam as a layer coupled to the passenger facing surface of a vehicle seat base layer;

FIG. 4A is a partial sectional view showing a conductive particle electronic foam discretely coupled to the vehicle seat based layer in a zoned configuration; and

FIG. 4B is a forward facing sectional and side sectional view of a vehicle seat back or seat bottom showing an alternative conductive particle electronic zone pattern in the front and side sectional views.

### DETAILED DESCRIPTION

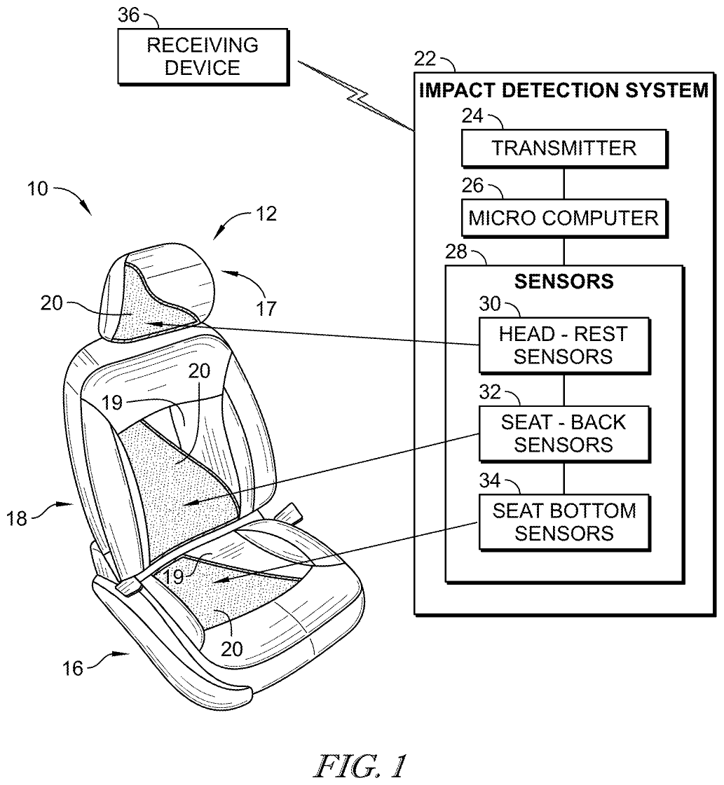

An occupant support 10, as illustrated in FIG. 1, includes a vehicle seat 12 and an impact detection system 22. The vehicle seat 12 is configured to support an occupant within a vehicle and includes a seat bottom 16 arranged to overlie a vehicle floor, a seat back 18 arranged to extend upward from the seat bottom 16, and a headrest 17 included in the seat back and arranged to extend upward from the seat back 18. Each of the seat bottom 16, seat back 18, and headrest 17 have an exterior seat cover 19 and a cushion 20 interior to the seat cover 19 to support an occupant.

The impact detection system 22 is coupled to at least one of the seat bottom 16 and the seat back 18 and is configured to detect and transmit information regarding impacts experienced by the occupant. A microprocessor 26, included in the impact detection system 22, may receive signals from one or more sensors 28 and determine based on predefined criteria whether an impact has occurred. Based on this determination microprocessor 26 may automatically transmit impact information in real-time via a transmitter 24 to a receiving device 36 located in a remote position relative to the vehicle seat 12.

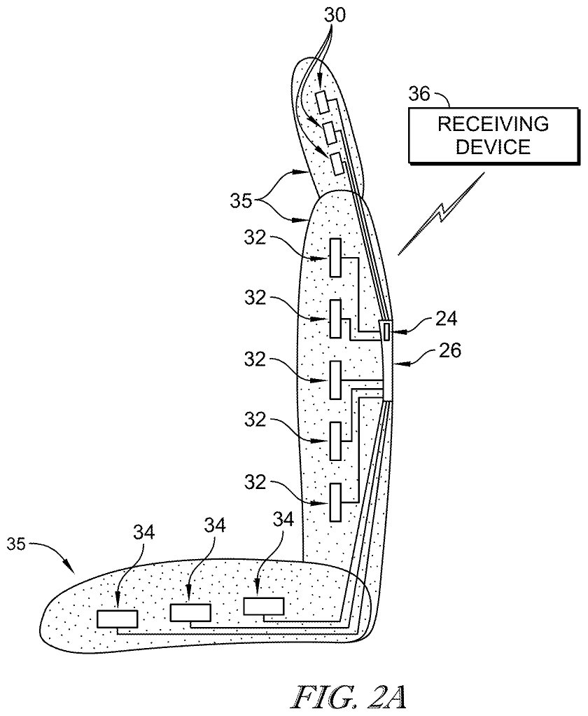

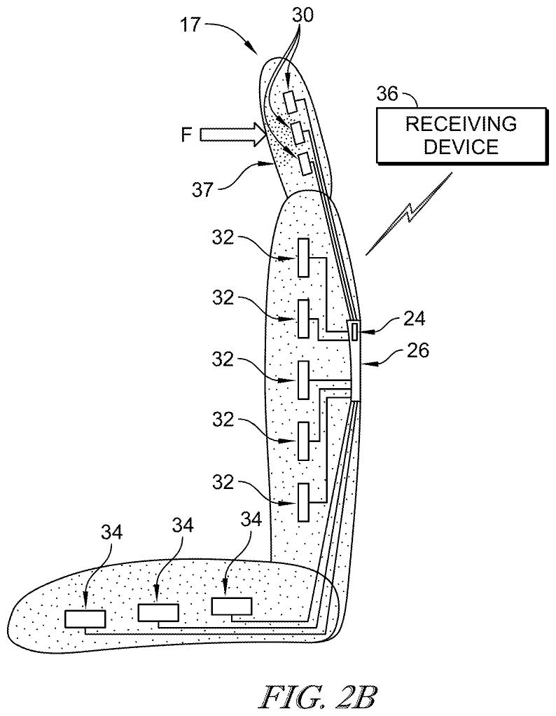

The cushion 20 may comprise composite conductive foam material 35 and one or more headrest sensors 30, seat back sensors 32 and/or seat bottom sensors 34 embedded in the cushion 20 as shown in FIG. 2. The composite conductive foam 35 comprises a foam that is formed by adding semi-conductive particles to the formulation resulting in a distribution of the semi-conductive particles in the foam of in a predefined density. Semi-conductive particles may include graphene, nickel, any other suitable semi-conductive particles, or combinations thereof.

One or more of the sensors 30, 32, 34 comprise conductive electrodes in the conductive foam material 35 that detect an impact from an occupant at rest in the seat. The sensors 30, 32, 34 detect impact via electrical signals generated from the compression of the semi-conductive particles in the foam. The sensors may also include timers for determining a duration of increase and/or decrease of voltage from the impact experienced by the foam from the occupant in the seat. The sensors comprise a load or shock detector, micro-voltage detector, or a strain gauge. The sensors further comprise accelerometers. Microcomputer 26 may collect, analyze, and transmit information based on the signals in real time to a remote device 36.

As seen in FIG. 2B, a force F, such as by an occupant's head may hit the vehicle seat headrest 17. This compresses the composite conductive foam material 35 so that the particles rub against each other and generate a charge. As the foam becomes more compressed, density increases, and the semi-conductive particles 37 become more concentrated in the region of the force F. One or more headrest sensors 30 detect the charge and register a spike in voltage generated by the charge. Increased impact or force will result in a relatively larger voltage spike than a relatively small force.

Sensed voltages are sent to microcomputer 26, which may further process these voltages to determine one or more of impact velocity, acceleration, magnitude and direction. Microcomputer 26 may include one or more stored sets of instructions calculating impact velocity, acceleration, magnitude and direction and location values as well as instructions and criteria for when and where to transmit impact information. For example, the microcomputer may only transmit impact information if the one or more impact values exceeds a predefined threshold or meets predefined criteria. The predetermined threshold may be related to a force imparted on the occupant and the predefined criteria may be the age, fitness, and or other health impairments of the occupant.

In one example, if the one or more impact values exceed a predefined value the microcontroller determines the vehicle has been involved in an accident and contacts emergency services with impact information. This may include GPS coordinates of the vehicle and location on the occupant body where impact was greatest.

In another example, if the one or more impact values exceed a predefined value and the impact values were sensed in the headrest location, a message is sent to emergency services and/or a personal contact of the occupant that the person may have experienced head trauma. The message may include a location of the vehicle. The message may be an electronic message such as an SMS message, email, or may be a telephone call. The receiving device 36 may be an electronic device capable of receiving the sent message format, such as a personal computer, mobile phone, or tablet. In some examples, the microcomputer is configured to send messages to systems integrated into the vehicle in order to affect performance of these systems such as, but not limited to, airbag deployment systems.

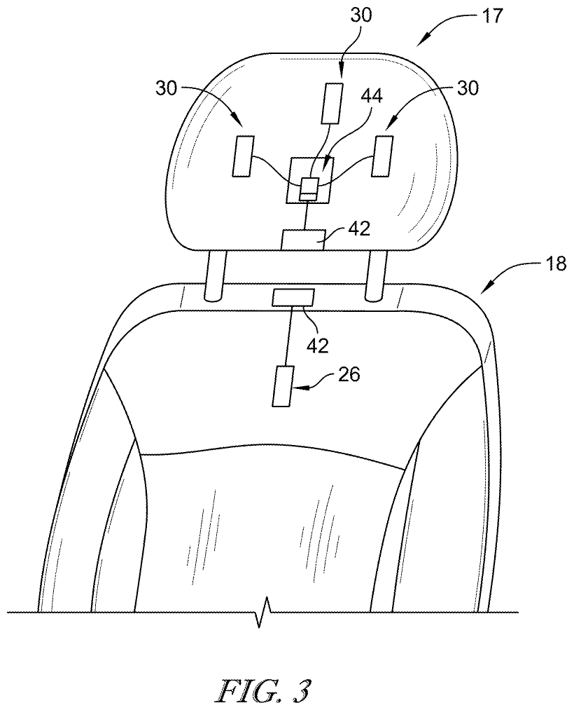

Another headrest embodiment is provided in which the headrest is movable relative to the seat back 18 as shown in FIG. 3. Headrest sensors 30 are configured to communicate sensed impact signals wirelessly from headrest sensors 30 to microcomputer 26. Seat back 18 may be configured similarly to the seat back in FIGS. 1, 2A, and 2B. Signals detected by the one or more headrest sensors 30 may be transmitted via transceiver 38 in the headrest and received by transceiver 42 coupled to the microcomputer 26. The headrest may include a controller 42, such as a microprocessor for controlling collection and transmission of the signals. Furthermore, power may be transmitted from transceiver 42 in the seat back to headrest transceiver 38 and stored locally on the microprocessor as needed. This permits the headrest height to be adjusted while avoiding exposed wiring of the wired embodiments. Reference is hereby made to U.S. application Ser. No. 16/013,183, filed May 20, 2018 and entitled HEADREST FOR A VEHICLE SEAT for disclosure relating wireless headrest communications, which application is hereby incorporated in its entirety herein. In another example, the headrest may be integrated with the seat back such that there is no movement of the headrest relative to the seat back.

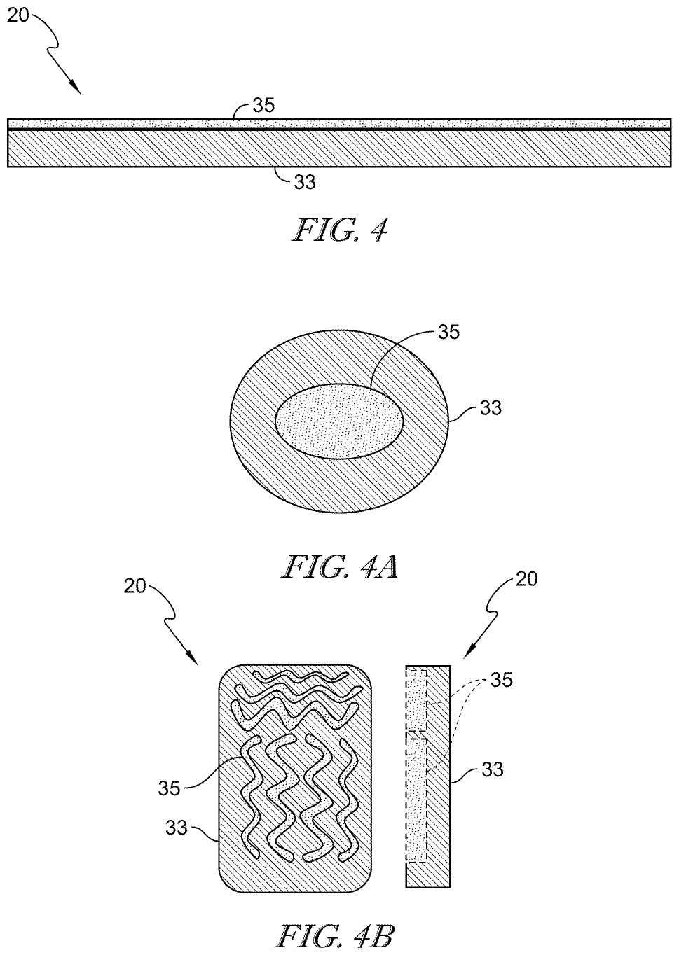

The composite conductive foam material 35 may be integrated into a cushion 20 of the vehicle seat 12 in a plurality of different manners as shown in FIGS. 4, 4A, and 4B. For example, in FIG. 4, the composite conductive foam material 35 is a continuous layer on an occupant-facing portion of the cushion, which is coupled to a base foam layer 33. In some embodiments, composite conductive foam material 35 is formed in a discrete zone on a base foam layer 33 as shown in FIG. 4A. In this embodiment, one or more zones may be formed in the headrest, seat back, or seat bottom, depending on a location of interest identified to detect forces.

The composite conductive foam material 35 may take on a plurality of different patterns and be coupled to the based foam layer 33 of the cushion as shown in FIG. 4B. In this embodiment, the composite conductive foam material 35 is embedded in the base foam layer 33 to provide a continuous occupant-facing surface with the base foam layer. However, in some embodiments, the conductive foam material 35 of the zoned or patterned configurations may extend out beyond the surface of the base foam layer toward the occupant forming a contour relative to the surface of the base foam layer 33. The base foam layer 33 may comprise non-conductive materials used to form vehicle seat cushions such as polyurethane. One example of a composite conductive foam material may be 5770 series conductive foam available from Holland Shielding Systems BV of the Netherlands. The 5770 series Conductive Foam Technical Datasheet is hereby incorporated by reference in its entirety.

1. A vehicle seat comprising
a seat bottom and a seat back coupled to the seat bottom to extend upwardly away from the seat bottom and move relative to the seat bottom and
an impact detection system coupled to one of the seat bottom and the seat back, the impact detection system comprising conductive particle electronic foam, a sensor configured to detect changes in density of the conductive particle electronic foam, and a microcomputer configured to analyze the detected changes in density and transmit a message to a remote device.

2. The vehicle seat of claim 1, wherein the conductive particle electronic foam includes a foam material and semi-conductive particles of one of graphene or nickel dispersed in a predetermined density in the foam material.

3. The vehicle seta of claim 2, wherein, in response to an external impact force applied to the conductive particle electronic foam, the semi-conductive particles generate a static charge and the sensor detects a voltage.

4. The vehicle seat of claim 3, wherein the microcomputer is configured to determine one or more of impact velocity, acceleration, magnitude, and direction.

5. The vehicle seat of claim 4, wherein the microcomputer is coupled to a transmitter and is configured to transmit a message to one or more predetermined remote devices in response to a result of the analyzed voltage meeting predefined criteria.

6. The vehicle seat of claim 1, wherein the impact detection system comprises a plurality of sensors positioned in the seat bottom, the seat back, and the headrest.

7. The vehicle seat of claim 1, wherein the sensor comprises one or more of strain gauges and micro-voltages sensors.

8. The vehicle seat of claim 1, wherein the transmitted message relays the vehicle occupant has experienced head trauma.

9. A vehicle seat comprising
a seat bottom, a backrest coupled to the seat bottom to extend upwardly away from the seat bottom and move relative to the seat bottom, and a headrest coupled to the backrest, and
an impact detection system comprising conductive particle electronic foam, a plurality of sensors configured to detect changes in density of the particle foam and arranged in the headrest, and a microcomputer configured to analyze the detected changes in density and transmit a message to a remote device.

10. The vehicle seat of claim 9, wherein the particle electronic foam includes semi-conductive particles of one of graphene or nickel dispersed in a predetermined density in the foam.

11. The vehicle seta of claim 10, wherein, in response to an external impact force applied to the particle electronic foam, the semi-conductive particles generate a static charge and the sensor detects a voltage.

12. The vehicle seat of claim 11, wherein the microcomputer is configured to determine one or more of impact velocity, acceleration, magnitude, and direction.

13. The vehicle seat of claim 12, wherein the microcomputer is coupled to a transmitter and is configured to transmit a message to one or more predetermined remote devices in response to a result of the analyzed voltage meeting predefined criteria.

14. The vehicle seat of claim 9, wherein the particle electronic foam and the plurality of sensors are further arranged in the seat back and the seat bottom.

15. The vehicle seat of claim 9, wherein the microcomputer is arranged in the seat back and the plurality of sensors are configured to wirelessly communicate detected changes in density to the microcomputer.

16. The vehicle seat of claim 9, wherein the sensor comprises one or more of strain gauges and micro-voltages sensors.

17. The vehicle seat of claim 9, wherein the transmitted message relays the vehicle occupant has experienced head trauma.
